(19) United States
(12) Patent Application Publication
(10) Pub. No.: US 2025/0270875 A1
(43) Pub. Date: Aug. 28, 2025

(54) INTERLOCK ASSEMBLY, AND MULTI-SLIDE PANEL SYSTEM USING SAME

(71) Applicant: Tecnoglass, Inc., Miami, FL (US)

(72) Inventors: Cameron WYATT, Gilbert, AZ (US); Samir Sabagh, Miami, FL (US); Sarah J. Hardecopf, Gilbert, AZ (US); Daniel Daes, Key Biscayne, FL (US)

(21) Appl. No.: 19/030,344

(22) Filed: Jan. 17, 2025

Related U.S. Application Data
(60) Provisional application No. 63/558,542, filed on Feb. 27, 2024.

(51) Int. Cl. E06B 7/16; E06B 3/42

(52) U.S. Cl. CPC E06B 7/16; E06B 3/42

(57) ABSTRACT

An interlock assembly, comprising a strut having a strut extension, a frame member fixedly attached to the strut. An interlock assembly, additionally wherein the strut and the frame member extend longitudinally from a first end to a second end and are configured to retain an end of a panel member. Further a notch is formed through the strut and the frame member at one of the first end or the second end, wherein the notch is configured to receive a plate member of a connecting frame member, and wherein a first portion of the strut extension is to an interior side of the plate member and a second portion of the strut extension is to an exterior side of the plate member. Additionally, a sliding panel system is described that includes the interlock assembly.

### CROSS REFERENCE TO RELATED APPLICATIONS

The present application claims priority to U.S. Provisional Application No. 63/558,542, filed Feb. 27, 2024, which is hereby incorporated by reference herein in its entirety.

### TECHNICAL FIELD

The present disclosure generally relates to a multiple panel (e.g., window or door) system, with at least one sliding panel, and an interlock assembly for use therein.

### BACKGROUND

Many current multi-slide panel systems have an interlock assembly formed using two interlocks, each on a different frame track plane, with their interaction occurring at a 180° offset. One issue with using a system that requires two non-symmetrical interlocks is that more parts are required (a unique interior or unique exterior interlock), or additional assembly steps are required to transform them from interior or exterior interlocks. Further, to make an interlock symmetric results in a non-optimal strut placement location. This non-symmetrical system currently in place can result in extended amounts of labor, cost of materials and can result in a lack of thermal efficiency or sealing efficiency. The makes the current non-symmetrical interlock systems currently in place a bad choice for modern multi-slide panel systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an interlock assembly including a strut having a strut extension and a frame member fixedly attached to the strut. The strut and the frame member extend longitudinally from a first end to a second end and are configured to retain an end of a panel member. The interlock assembly additionally includes a notch formed through the strut and the frame member at one of the first end or the second end, wherein the notch is configured to receive a plate member of a connecting frame member, and wherein a first portion of the strut extension is to an interior side of the plate member and a second portion of the strut extension is to an exterior side of the plate member.

In some aspects, the present disclosure includes a sliding panel system having a first panel member positioned on a first track of the sliding panel system and a second panel member positioned on a second track of the sliding panel system, wherein the second panel member is movable on the second track relative to the first panel member. The system further includes a first interlock assembly on the first panel member including a first strut having a first strut extension and a first frame member fixedly attached to the first strut. The first strut and the first frame member extend longitudinally from a first end to a second end and are configured to retain an end of a first panel member. The first interlock assembly further includes a first notch formed through the first strut and the first frame member at one of the first end or the second end, wherein the first notch is configured to receive a first plate member of a first connecting frame member, and wherein a first portion of the first strut extension is to an interior side of the first plate member and a second portion of the first strut extension is to an exterior side of the first plate member. The system additionally includes a second interlock assembly on the second panel member including a second strut having a second strut extension and a second frame member fixedly attached to the second strut. The second strut and the second frame member extend longitudinally from a first end to a second end and are configured to retain an end of a second panel member. and the second interlock assembly further includes a second notch formed through the second strut and the second frame member at one of the first end or the second end, wherein the second notch is configured to receive a second plate member of a second connecting frame member. Also, a first portion of the second strut extension is to an interior side of the second plate member and a second portion of the second strut extension is to an exterior side of the second plate member. Further, respective strut hook members of the first interlock assembly and the second interlock assembly are configured to seal a gap between the first panel member and the second panel member when the second panel member is moved to a closed position.

These and additional aspects of the present disclosure are described in more detail below.

### BRIEF DESCRIPTION OF THE DRAWINGS

FIG. 1 is a front view of an example of a multi-slide panel system including a sill assembly according to the present aspects;

FIG. 2 is a right side view of the multi-slide panel system of FIG. 1;

FIG. 3 is a partial top, cross-sectional view of the multi-slide panel system of FIG. 1, with the longitudinal length of each panel member abbreviated and with the sill assembly removed for the sake of clarity, wherein a gap between adjacent panel members is sealed with a corresponding pair of symmetric interlock assemblies;

FIG. 4 is a top cross-sectional view of one of the interlock assemblies of FIGS. 1-3;

FIG. 5 is an enlarged, magnified partial top, cross-sectional view the dashed line area in FIG. 3, including of the engagement of opposing interlock assemblies;

FIG. 6 is an isometric view of a portion of a panel member including a cut-away portion of an interlock assembly of FIGS. 1 and 3-5;

FIG. 7 is an exploded perspective view of a panel member of the multi-slide panel system of FIG. 1 and corresponding frame members, including the interlock assembly as described herein; and

FIG. 8 is an enlarged, front left perspective view of the dashed line area in FIG. 7, including a portion of the interlock assembly described herein having a notched area for connection with a top frame member of the multi-slide panel system of FIG. 1.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

An interlock assembly is an item of a sliding or multi-sliding door or window system that provides a seal between two different panels on different tracks, meaning a seal to another panel that is one track width distance away. Interlock assemblies are designed to work in pairs, meaning an interlock system will include two interlock assemblies, each on a different frame track plane, with their interaction occurring at a 180° offset.

Aspects of the disclosure include an interlock assembly for a multi-panel system, wherein the interlock assembly is configured as a symmetric interlock assembly such that each interlock assembly may be placed on any side of a panel to accommodate various different panel configurations. Each interlock assembly will be attachable to a panel on at least one side of the panel and will movably mate with a corresponding interlock assembly on an opposing side of adjacent panel when the panels move into a fully closed position. Each interlock assembly includes a strut and a frame member which together work to attach the interlock assembly to a panel member.

The frame member includes a first crimp member on the interlocking side and a second crimp member on the side opposite the interlocking side. The first crimp member and second crimp member each hold an extrusion of the strut to hold the strut in place in the frame member. The strut and frame member each further include a strut hook member and a frame member wall member respectively. The strut first wall member extends along the portion of the panel member adjacent to an opposing panel and the frame member first wall member extends along the opposing side of the panel member to create a U-shape around the panel member and to thereby affix the interlock assembly to the panel member. Additionally the strut and frame member may be additionally affixed to the panel member through a securing means into the side of the panel.

Thus, the disclosed interlock assembly provides a multi-slide panel system with an interlock assembly that is symmetrical and easier to produce and install, and requiring reduced inventory, when compared to existing solutions.

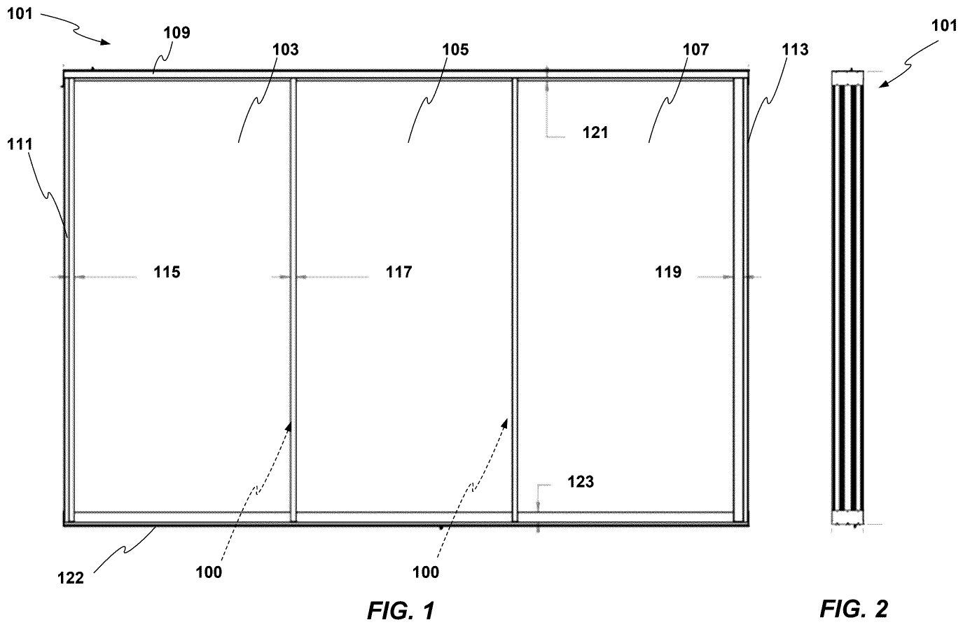

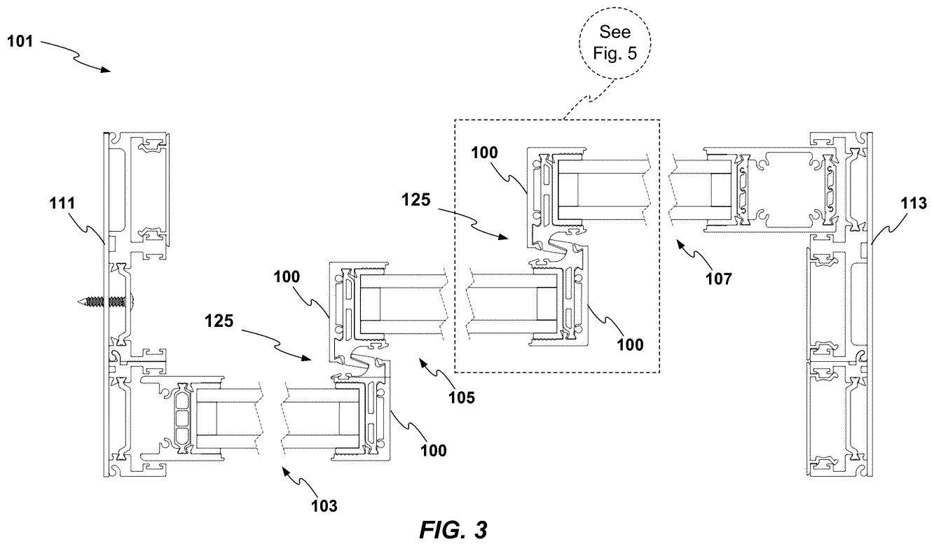

Referring to FIGS. 1-3, according to one example, a multi-slide panel system 101 includes a first panel 103, a second panel 105, and a third panel 107 each including at least one interlock assembly 100 of an opposing pair of interlock assemblies 125 to provide a vertically-extending seal between two adjacent panels, at least one of which is movable relative to the other. The panels 103, 105, and 107 are supported within a frame system that includes a multi-track sill assembly 122 at a bottom side, a multi-track top frame 109 at a top side, and opposing end frames 111 and 113 at each end. The panels 103, 105, and 107 of the multi-slide panel system 101 may be, for example, doors and/or windows. At least one, and preferably two, of the first panel 103, the second panel 105, and the third panel 107 is/are slidably movable with the frame system. For instance, the first panel 103 may be a fixed panel, and the second panel 105 may be slidable (e.g., to the left in the example of FIG. 1) to overlap with the first panel 103, and the third panel 107 may be slidable (e.g., to the left in the example of FIG. 1) to overlap with both the first panel 103 and the second panel 105. The multi-slide panel system 101 may be configured with relatively narrow frame members, compared to prior solutions, to provide a sleek, modern look that minimizes the reveal widths, e.g., a fixed panel reveal 115, an interlock reveal 117, a lead panel reveal 119, a top rail reveal 121, and a bottom rail reveal 123, thereby maximizing a view through the panels 103, 105 and 107. The panels 103, 105 and 107 may include a single or multi-pane sheet of a transparent, translucent, or non-transparent material, such as but not limited to a glass, a plastic, or a wood material. In a typical example, the panels 103, 105 and 107 include two or three panes of glass, which can be sealed and filled with an insulating material therebetween, such as a gas having a lower thermal conductivity than air. An example of one such gas includes argon. In any case, the interlock assembly 100 of the multi-slide panel system 101 provides an improvement over current solutions, as the interlock assembly 100 of the present disclosure is symmetric. In other words, the same interlock assembly 100 can be used on each of the opposing pair of interlocker assemblies 125. For example, referring to FIG. 3, the interlock assembly 100 on the back, right side of panel member 105 is identical to the interlock assembly 100 on the front left side of panel member 107, e.g., one interlock assembly 100 is rotated 180 degrees about its longitudinal axis relative to the other one. Having a symmetric interlock assembly 100 reduces the labor required to manufacture the interlock assembly, and reduces the required amount of inventory (since all interlock assemblies are the same). One or more other aspects of the interlock assembly 100 also provide improvements over existing solutions, such as but not limited to: a mounting extension on a strut of the interlock assembly having a large area that aids in certain aspects with connecting to other frame members; a hybrid configuration of a metal frame member and non-metal strut, which reduces thermal energy transfer; strategically located crimp locations to avoid crimp lines from being within sight lines; and, a relatively narrow interlock reveal, as compared to existing solutions. Each of these features is discussed in more detail below.

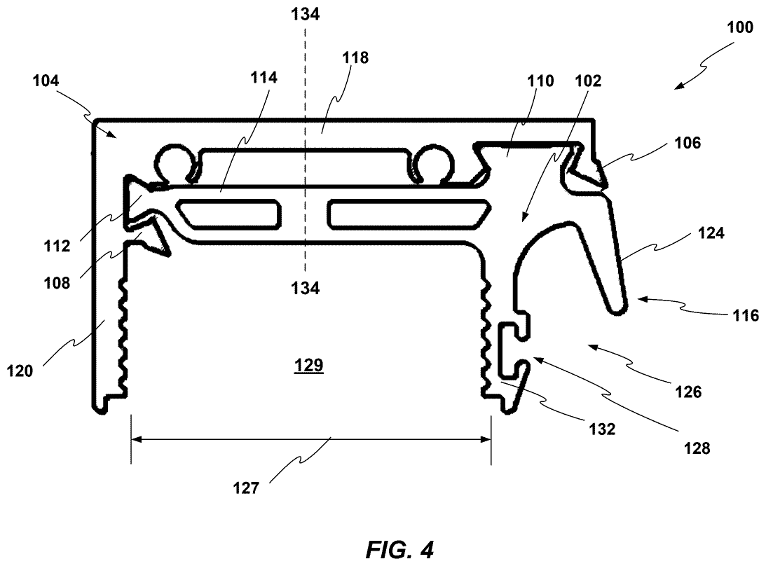

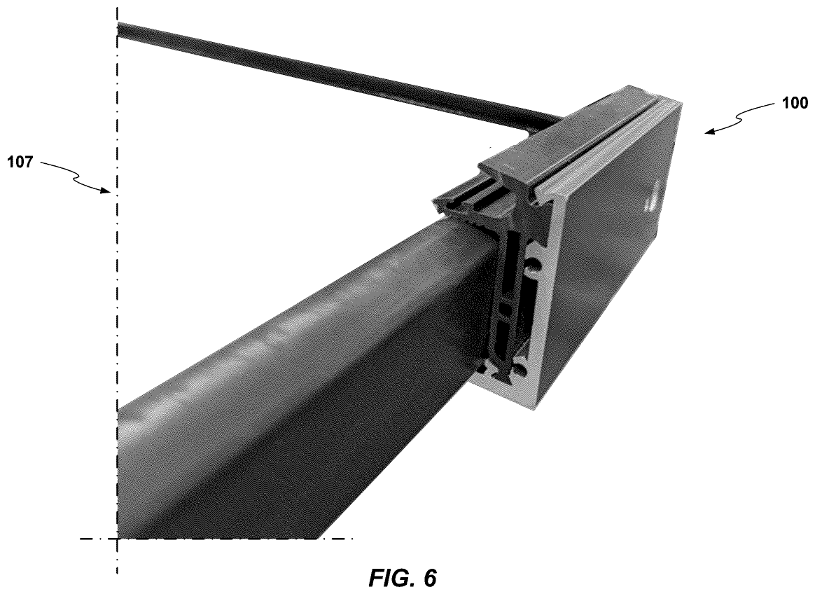

Referring to FIGS. 4-7, in the example implementation of FIGS. 1-3, which should not be construed as limiting, the example interlock assembly 100 includes a strut 102 fixedly positioned within a frame member 104. The frame member 104 includes a first crimp member 106 and a second crimp member 108, which hold or mate with a first strut extension 110 and a second strut extension 112 respectively to hold the strut within the frame member 104. The strut 102 further includes a strut base member 114 that extends across a thickness or depth 127 of the respective panel member, and a strut hook member 116 having a hook shape that supports a face of a respective panel member on one side and that forms an interlocking groove for engagement and sealing with an opposing interlock assembly. The frame member 104 further includes a frame base member 118 that extends along the thickness or depth 127 of the respective panel member, and a frame wall member 120 that opposes the strut hook member 116 to cooperatively support the respective panel member. The strut base member 114 and strut hook member 116 form a first L-shape, and the frame base member 118 and frame wall member 120 form an opposite L-shape. The strut base member 114 and frame base member 118 each extend adjacent to one another in a parallel direction. The strut hook member 116 extends in a perpendicular direction, relative to the strut base member 114 and frame base member 118, on one side of the interlock assembly 100, and the frame wall member 120 extends in a perpendicular direction on an opposing side to define a panel-retaining channel 129. As such, the interlock assembly 100 has a U-shaped (or inverted U-shaped) cross-section when the strut 102 and frame member 104 are attached to one another.

The panel-retaining channel 129 is configured to fixedly hold a respective one of the panel members 103, 105, or 107 such that the strut hook member 116 will extend along the edge of a first face of the respective panel member and the frame wall member 120 will extend along the edge of a second face of the respective panel member. Advantageously, as the strut 102 is configured to have a lower thermal conductivity than the frame member 104, the configuration of the strut 102 covering the end and a part of an interior side of a respective panel cuts off a thermal path through the frame member 104, thereby providing the interlock assembly 100 with improved thermal performance.

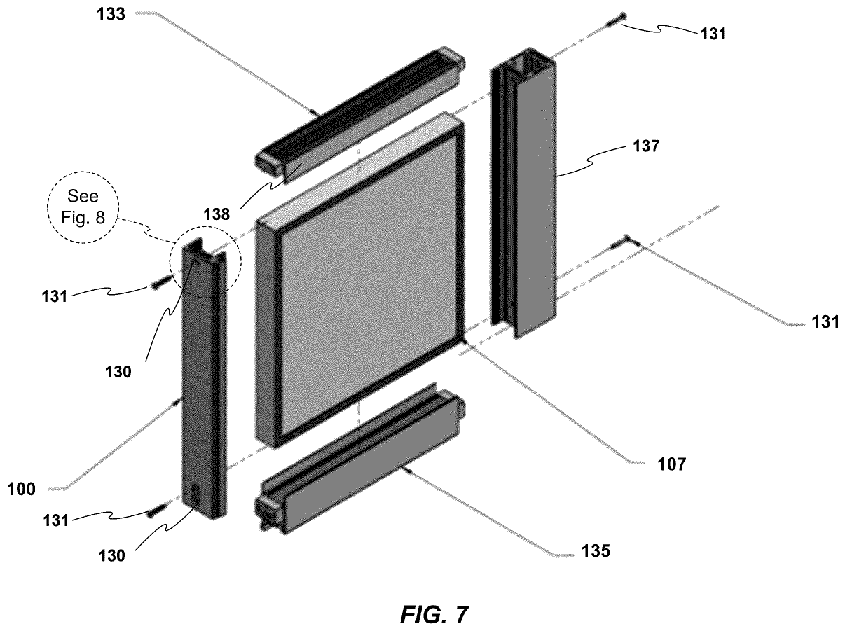

Referring specifically to FIG. 7, as an interlock assembly 100 extends the full, vertical length at least end of a respective panel member, such as the left end of panel member 107 in this example, the interlock assembly 100 thereby creates a U-shape around a full length vertical edge of the respective panel member 107. The interlock assembly 100 can be further affixed to retain the panel member 107 by inserting a securing mechanism 131, such as a screw or bolt, through the frame base member 118 and further through the strut base member 114 into a top rail sub-assembly 133 and a bottom rail/roller sub-assembly 135 of the panel member 107. Additionally, in this case, the framing of the panel member 107 is completed by an end frame member 137 affixed to the top rail sub-assembly 133 and the bottom rail/roller sub-assembly 135 by the securing mechanism 131. Additionally, in an aspect, the securing mechanism 131 may be inserted along line 134-134 (see FIG. 4, and also see FIG. 7) such that the securing mechanism 131 is secured through a full thickness of the strut base member 114 in order to provide a secure connection.

Referring back to FIG. 4, as discussed above, the strut 102 is held within the frame member 104 through the use of the first crimp member 106 and the second crimp member 108 of the frame member 104, each of which includes a substantially non-elastically deformable tab that is crimped to hold or mate with the first strut extension 110 and the second strut extension 112, respectively. The first crimp member 106 of the frame member 104 is located at the distal end of the frame member base member 118 and the second crimp member 108 is located in the frame wall member 120 at a point adjacent to a location where the frame base member 118 and the frame wall member 120 meet. The first strut extension of 110 is located at the distal end of the strut base member 114 and mates with the second crimp member 108, and the second strut extension 112 is located at the opposing end of the strut base member 114 on the outside at the point where the strut base member 114 meets the strut hook member 116. The second strut extension 112 mates with the second crimp member 108.

This described configuration of the strut 102 and the frame member 104 provides numerous benefits, First, the first crimp member 106, on the interlocking side, or the non-visible side, and the second crimp member 108 located within the frame member 104 may complete the hybrid connection between the strut 102 and frame member 104. As used herein, the term hybrid connection refers to the difference in materials used to form the interlock assembly 100, which may provide differences in thermal conductivity. For instance, in an aspect, in order to reduce the transfer of thermal energy from one side (such as an exterior side) to another side (such as an interior side) of the interconnect assembly 100, the strut 102 have a first thermal conductivity that is less than a second thermal conductivity of frame member 104. For example, the strut 102 may be made from a plastic material, such as but not limited to a polyamide, while the frame member 104 made be made from a metal material, such as but not limited to an aluminum. It should be understood, however, that any of a plurality of different materials may be used for each of these components, and in some aspects they both may be made from a same material. Second, a backup roller of a crimping machine can utilize the relatively long frame wall member 120 to crimp the first crimp member 106 without deforming the structure of the frame member 104. And, another backup roller of the crimping machine utilize the relatively long frame base member 118 to crimp the second crimp member 108 without deforming the structure of the frame member 104. In some cases, both the first and second crimping operations on the first and second crimp members 106, 108 can be performed at the same time. This structural stability is advantageous to efficient crimping, as many interlockers bend during the crimping process and require complex strutting steps like supporting the parts or doing multiple passes. Third, the structure described herein allows for the longest possible strut 102, measured from a distal end of the strut hook member 116 to an opposite distal end of the strut base member 114, which creates high energy efficiency. Fourth, besides being symmetrical, the interlock assembly 100 of the present disclosure is configured to be a bypass interlock. For example, the interlock assembly 100 has a low profile (e.g., extends a short distance away from the panel) that enables the panel locks or other hardware to bypass or avoid interfering with the interlock assembly 100 when the panels are moved from one position to another. Thus, the interlock assembly 100 described herein provides good manufacturability due to the good crimping support and no bending, excellent thermal properties, and enhanced aesthetics as both crimps are hidden from view.

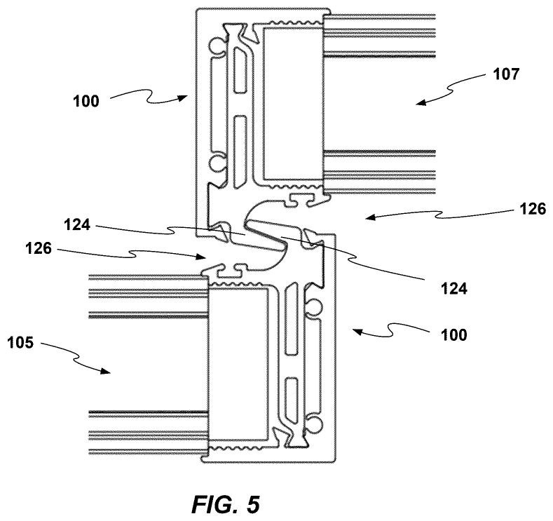

In an aspect, the strut hook member 116 includes an interlock member 124 spaced apart from a panel-retaining wall 132 to define an interlock groove 126 configured to sealingly engage with a corresponding interlock groove of an opposing interlock assembly. The interlock member 124 extends from the strut base member 114 to define an outside wall of the strut hook member 116. Relative to panel-retaining wall 132, the interlock member 124 may extend at an angle in a range of 10 degrees to 50 degrees, or more preferably in a range of 20 degrees to 40 degrees. This angle and length of the interlock member 124 at least partially defines a depth of the interlock groove 126 located between the interlock member 124 and the strut hook member 116. This interlock groove 126 is configured to receive the interlock member 124 of an opposing interlock assembly 100 as can be seen in FIG. 5.

Referring specifically to FIG. 5, for example, when two panel members of a multi-slide panel system 101, such as panel members 107 and 105 in this example, are being moved to the closed position, a first interlock assembly 100 of panel member 107 will move towards a second interlock assembly 100 of panel member 105, and the respective interlock members 124 will move into the respective interlock grooves 126 to close the gap between the panel members 107 and 105. In other words, the respective interlocks 124 will then engage with one another and/or with the opposing interlock grooves 126, creating a seal between the respective struts 102 of the respective interlock assemblies 100.

Moreover, as mentioned above, the interaction of the opposing interlocking assemblies 100 described above in relation to FIG. 5 provides the maximum combined strut length between the strut 102 of the interlock assembly 100 of panel member 107 and the strut 102 of the interlock assembly 100 of panel member 105. This extended strut length provides a dramatic increase in the thermal properties of the interlock system. As described previously, in an aspect, the frame member 104 is made of a material such as aluminum or a similar material with good strength, malleability and weather resistance, and it can be made to look good aesthetically, however, aluminum does not include good thermal properties. The strut 102, on the other hand, located within the frame member 104, is comprised of a material with good thermal properties such as a rubber or plastic material. It is therefore advantageous to increase the length of the strut as much as possible to increase the thermal efficiency of the interlock assembly 100 and/or the combined interlock assemblies 100. Additionally the surface of the interlock member 124, which engages the opposing interlock is strutted, which provides the largest surface area possible for the interlock member 124, and the connection between one panel to the next has the lowest thermal conductivity possible. Other prior solutions, which do not perform as well as the present system, include designs have metal tangs, and these can have exposure to conduction paths along the interior glass thereby reducing the thermal properties.

The side of the strut hook member 116 facing away from the respective panel member further includes a groove 128 configured to removably hold a weatherstrip material, which can extend so fill the interlock groove 126. The weatherstrip groove 128 is located at the distal end of the strut hook member 116, such as toward a front of, or in front of, the interlock groove 126. The weather strip groove 128 allows for a weatherstrip to be inserted into the groove, and the weatherstrip can interact will the interlock member 124 of the opposing interlock assembly. This weatherstrip located in the weatherstrip groove 128 can provide additional protection for the interlock assembly 100 from external elements as well as provide additional thermal properties. Finally, the weatherstrip can hide the internal elements of the interlock assembly 100, thereby increasing the aesthetic appeal of the interlock system.

Referring specifically to FIG. 7, the interlock assembly 100 further includes securing openings 130. The securing openings 130, may include screw holes for use at the bottom and top of the interlock assembly 100 to attach various components to the interlock assembly 100. The securing openings 130, apart from providing additional securing mechanisms to attach additional components to the interlock assembly 100, the location of these securing openings further improves weatherization, and these securing openings 130 are not visible from the outside and therefore do not reduce the aesthetic appeal.

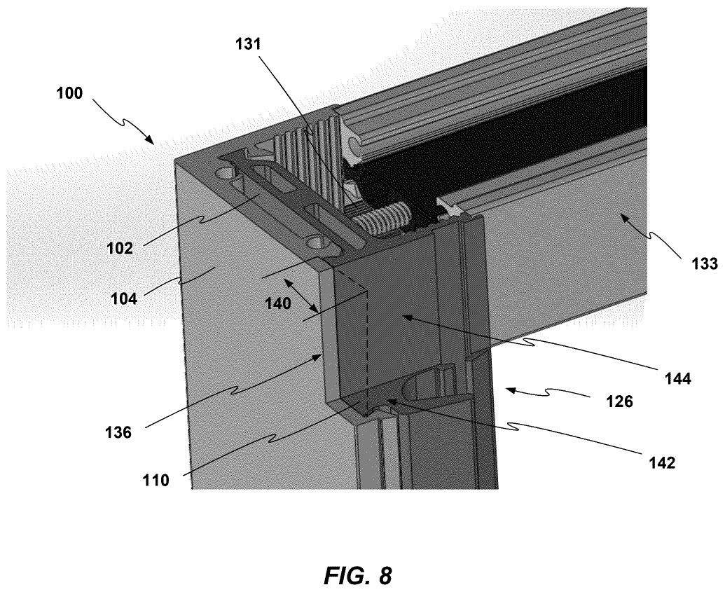

Referring to FIGS. 7 and 8, in an aspect, the interlock assembly 100 is further configured to have a notch 136, such as an area of the strut 102 and the frame member 104, removed to accommodate a plate 138 (see FIG. 7) of the top rail sub-assembly 133 when the interlock assembly 100 is secured to the top rail sub-assembly 133 via the securing mechanism 131. Advantageously, the first strut extension 110 if the interlock assembly 100 has a depth 140 configured to provide sufficient structural support to both the reduced area 142 of the interlock groove 126, e.g., to the outside of the plate 138, as well as the reduced area 144 of the remaining portion of the first strut extension interior to the plate 138. In other words, the first strut extension 110 overlaps both the interior and exterior of the panel member 107. As such, due to the size of the first strut extension 110, even in view of the formation of the notch 136, the configuration as described herein avoids forming a void (e.g., an opening to the interior) in the notched area, thereby providing an improved thermal design.

Thus, in an implementation, the present disclosure provides for a high performance symmetric aluminum/polyamide interlock assembly that has unique thermal efficiency, aesthetic, and manufacturing processing advantages compared to prior solutions.

In some aspect, when designing an interlock assembly, one or more of the following criteria may be utilized.

Narrowness in site line and frame depth—Narrowness being defined in dimension corresponding to the interlock reveal 117. Frame depth being defined as dimension from in interior to an exterior of the panel. Customers want both of these minimized. U-factor is improved if narrowness in site line is minimized. Cost can be reduced with a smaller part as well (less material mass).

Bending strength—as being defined as the force required to bend the interlocker along the plane orthogonal to FIG. 4. More bending strength is optimal, as the door performs better in structural ratings.

Thermal efficiency/sealing efficiency—as defined by thermal conductivity, air infiltration, and overall system u-factor. This all should be as low as possible.

Aesthetics and other customer drivers—like finish options, tactile feel, and no visual struts, crimp lines or fastener heads. A smooth anodized aluminum surface would be the baseline for best, with everything else getting worse with any variance from this.

Symmetry (to reduce inventory)—not having interior exterior interlocks, handed interlocks, or additional covers, screws or features required to move an interlock from interior to exterior except a rotation.

Manufacturing and machinability concerns—can the profile be ran through standard rolling, crimping, cutting and machining equipment. When notching for the interlock does it leave a void, etc.

These criteria are sometimes diametrically opposed to each other (example bending strengths with frame depth). More frame depth of material increases bending strength all other things being equal.

The interlocker assembly of the present disclosure balances these characteristics by using one or more of the features described above.

Additionally, aspects of the disclosure may include one or more of the following clauses.

Clause 1. An interlock assembly, comprising: a strut having a strut extension; a frame member fixedly attached to the strut; wherein the strut and the frame member extend longitudinally from a first end to a second end and are configured to retain an end of a panel member; and a notch formed through the strut and the frame member at one of the first end or the second end, wherein the notch is configured to receive a plate member of a connecting frame member, and wherein a first portion of the strut extension is to an interior side of the plate member and a second portion of the strut extension is to an exterior side of the plate member.

Clause 2. The interlock assembly of clause 1, wherein the strut further comprises a strut hook member having a hook shape configured to sealingly connect with an opposing strut hook member of an opposing interlock assembly, wherein the strut hook member and the opposing strut hook member are identical shapes rotated 180 degree about a longitudinal axis.

Clause 3. The interlock assembly of any preceding clause, wherein the strut comprises a first material have a first thermal conductivity, and the frame member comprises a second material having a second thermal conductivity, wherein the first thermal conductivity is less than the second thermal conductivity.

Clause 4. The interlock assembly of any preceding clause, wherein the strut further comprises a panel-retaining wall, and wherein the frame member comprises a frame wall member spaced apart from the panel-retaining wall and defining a panel-retaining channel configured to fixedly hold the end of the panel member.

Clause 5. The interlock assembly of any preceding clause, wherein the interlock assembly has a symmetrical configuration that can be used on either side of an opposing pair of interlock assemblies.

Clause 6. The interlock assembly of any preceding clause, wherein a first one of the opposing pair of interlock assemblies is rotated 180 degrees about its longitudinal axis relative to a second one of the opposing pair of interlock assemblies.

Clause 7. The interlock assembly of any preceding clause, wherein the strut contacts the end and a portion of an interior surface of the panel member and prevents direct contact between the frame member and the end and the portion of an interior surface of the panel member.

Clause 8. The interlock assembly of any preceding clause, wherein one side of the strut hook member further includes a groove configured to removably hold a weatherstrip material.

Clause 9. The interlock assembly of any preceding clause, further comprising at least one securing opening, wherein the at least one securing opening includes a screw hole to attach additional components to the interlock assembly.

Clause 10. A sliding panel system, comprising: a first panel member positioned on a first track of the sliding panel system; a second panel member positioned on a second track of the sliding panel system, wherein the second panel member is movable on the second track relative to the first panel member; a first interlock assembly on the first panel member comprising: a first strut having a first strut extension; a first frame member fixedly attached to the first strut; wherein the first strut and the first frame member extend longitudinally from a first end to a second end and are configured to retain an end of a first panel member; and a first notch formed through the first strut and the first frame member at one of the first end or the second end, wherein the first notch is configured to receive a first plate member of a first connecting frame member, and wherein a first portion of the first strut extension is to an interior side of the first plate member and a second portion of the first strut extension is to an exterior side of the first plate member; and a second interlock assembly on the second panel member comprising: a second strut having a second strut extension; a second frame member fixedly attached to the second strut; wherein the second strut and the second frame member extend longitudinally from a first end to a second end and are configured to retain an end of a second panel member; and a second notch formed through the second strut and the second frame member at one of the first end or the second end, wherein the second notch is configured to receive a second plate member of a second connecting frame member, and wherein a first portion of the second strut extension is to an interior side of the second plate member and a second portion of the second strut extension is to an exterior side of the second plate member; and wherein respective strut hook members of the first interlock assembly and the second interlock assembly are configured to seal a gap between the first panel member and the second panel member when the second panel member is moved to a closed position.

Clause 11. The sliding panel system of clause 10, wherein the first strut of the first interlock assembly further comprises a first strut hook member having a hook shape configured to sealingly connect with the second strut hook member of the second interlock assembly, wherein the first strut hook member and the second strut hook member are identical shapes rotated 180 degree about a longitudinal axis.

Clause 12. The sliding panel system of any preceding clause, wherein each strut comprises a first material having a first thermal conductivity, and each frame member comprises a second material having a second thermal conductivity, wherein the first thermal conductivity is less than the second thermal conductivity.

Clause 13. The sliding panel system of any preceding clause, wherein each strut further comprises a respective panel-retaining wall, and wherein each frame member comprises a respective frame wall member spaced apart from the respective panel-retaining wall and defining a respective panel-retaining channel configured to fixedly hold the end of each panel member.

Clause 14. The sliding panel system of any preceding clause, wherein each interlock assembly has a symmetrical configuration that can be used on either side of an opposing pair of interlock assemblies.

Clause 15. The sliding panel system of any preceding clause, wherein a first one of the opposing pair of interlock assemblies is rotated 180 degrees about its longitudinal axis relative to a second one of the opposing pair of interlock assemblies.

Clause 16. The sliding panel system of any preceding clause, wherein each strut contacts the end and a portion of an interior surface of the respective panel member and prevents direct contact between the respective frame member and the end and the portion of an interior surface of the respective panel member.

Clause 17. The sliding panel system of any preceding clause, wherein one side of each strut hook member further includes a groove configured to removably hold a weatherstrip material.

Clause 18. The sliding panel system of any preceding clause, wherein each interlock assembly further includes at least one securing opening, wherein the at least one securing opening includes a screw hole to attach additional components to the interlock assembly.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

What is claimed is:

1. An interlock assembly, comprising:
a strut having a strut extension;
a frame member fixedly attached to the strut;
wherein the strut and the frame member extend longitudinally from a first end to a second end and are configured to retain an end of a panel member; and
a notch formed through the strut and the frame member at one of the first end or the second end, wherein the notch is configured to receive a plate member of a connecting frame member, and wherein a first portion of the strut extension is to an interior side of the plate member and a second portion of the strut extension is to an exterior side of the plate member.

2. The interlock assembly of claim 1, wherein the strut further comprises a strut hook member having a hook shape configured to sealingly connect with an opposing strut hook member of an opposing interlock assembly, wherein the strut hook member and the opposing strut hook member are identical shapes rotated 180 degree about a longitudinal axis.

3. The interlock assembly of claim 1, wherein the strut comprises a first material having a first thermal conductivity, and the frame member comprises a second material having a second thermal conductivity, wherein the first thermal conductivity is less than the second thermal conductivity.

4. The interlock assembly of claim 1, wherein the strut further comprises a panel-retaining wall, and wherein the frame member comprises a frame wall member spaced apart from the panel-retaining wall and defining a panel-retaining channel configured to fixedly hold the end of the panel member.

5. The interlock assembly of claim 1, wherein the interlock assembly has a symmetrical configuration that can be used on either side of an opposing pair of interlock assemblies.

6. The interlock assembly of claim 5, wherein a first one of the opposing pair of interlock assemblies is rotated 180 degrees about its longitudinal axis relative to a second one of the opposing pair of interlock assemblies.

7. The interlock assembly of claim 1, wherein the strut contacts the end and a portion of an interior surface of the panel member and prevents direct contact between the frame member and the end and the portion of an interior surface of the panel member.

8. The interlock assembly of claim 2, wherein one side of the strut hook member further includes a groove configured to removably hold a weatherstrip material.

9. The interlock assembly of claim 1, further comprising at least one securing opening, wherein the at least one securing opening includes a screw hole to attach additional components to the interlock assembly.

10. A sliding panel system, comprising:
a first panel member positioned on a first track of the sliding panel system;
a second panel member positioned on a second track of the sliding panel system, wherein the second panel member is movable on the second track relative to the first panel member;
a first interlock assembly on the first panel member comprising:
a first strut having a first strut extension;
a first frame member fixedly attached to the first strut;
wherein the first strut and the first frame member extend longitudinally from a first end to a second end and are configured to retain an end of a first panel member; and
a first notch formed through the first strut and the first frame member at one of the first end or the second end, wherein the first notch is configured to receive a first plate member of a first connecting frame member, and wherein a first portion of the first strut extension is to an interior side of the first plate member and a second portion of the first strut extension is to an exterior side of the first plate member; and
a second interlock assembly on the second panel member comprising:
a second strut having a second strut extension;
a second frame member fixedly attached to the second strut;
wherein the second strut and the second frame member extend longitudinally from a first end to a second end and are configured to retain an end of a second panel member; and
a second notch formed through the second strut and the second frame member at one of the first end or the second end, wherein the second notch is configured to receive a second plate member of a second connecting frame member, and wherein a first portion of the second strut extension is to an interior side of the second plate member and a second portion of the second strut extension is to an exterior side of the second plate member; and
wherein respective strut hook members of the first interlock assembly and the second interlock assembly are configured to seal a gap between the first panel member and the second panel member when the second panel member is moved to a closed position.

11. The sliding panel system of claim 10, wherein the first strut of the first interlock assembly further comprises a first strut hook member having a hook shape configured to sealingly connect with the second strut hook member of the second interlock assembly, wherein the first strut hook member and the second strut hook member are identical shapes rotated 180 degree about a longitudinal axis.

12. The sliding panel system of claim 11, wherein each strut comprises a first material having a first thermal conductivity, and each frame member comprises a second material having a second thermal conductivity, wherein the first thermal conductivity is less than the second thermal conductivity.

13. The sliding panel system of claim 10, wherein each strut further comprises a respective panel-retaining wall, and wherein each frame member comprises a respective frame wall member spaced apart from the respective panel-retaining wall and defining a respective panel-retaining channel configured to fixedly hold the end of each panel member.

14. The sliding panel system of claim 10, wherein each interlock assembly has a symmetrical configuration that can be used on either side of an opposing pair of interlock assemblies.

15. The sliding panel system of claim 14, wherein a first one of the opposing pair of interlock assemblies is rotated 180 degrees about its longitudinal axis relative to a second one of the opposing pair of interlock assemblies.

16. The sliding panel system of claim 10, wherein each strut contacts the end and a portion of an interior surface of the respective panel member and prevents direct contact between the respective frame member and the end and the portion of an interior surface of the respective panel member.

17. The sliding panel system of claim 10, wherein one side of each strut hook member further includes a groove configured to removably hold a weatherstrip material.

18. The sliding panel system of claim 10, wherein each interlock assembly further includes at least one securing opening, wherein the at least one securing opening includes a screw hole to attach additional components to the interlock assembly.
